(19) United States
(12) Patent Application Publication
(10) Pub. No.: US 2012/0266963 A1
(43) Pub. Date: Oct. 25, 2012

(54) MIXING OF A LOWER DENSITY MATERIAL INTO A FLOW OF A HIGHER DENSITY MATERIAL

(75) Inventor: Robert Scott Decker, Carthage, MO (US)

(73) Assignee: ENVIROZONE SYSTEMS CORP., Carthage, MO (US)

(21) Appl. No.: 13/172,762

(22) Filed: Jun. 29, 2011

Related U.S. Application Data
(60) Provisional application No. 61/477,188, filed on Apr. 20, 2011.

(51) Int. Cl. B01F 3/04; B01F 15/02

(52) U.S. Cl. 137/1; 366/155.2; 261/74

(57) ABSTRACT

A mixer facilitates dissolving a lower density material into a higher density material using a rotating paddle to create a highly turbulent mixing zone in a mixing chamber adjacent to the flow of the higher density material. In an illustrated example, the mixer includes a motor that drives a mixing paddle to create a highly turbulent mixing of a liquid and a gas in the mixing chamber. The mixing paddle resides in a paddle chamber connected to the liquid transfer pipe by the mixing chamber. The mixing paddle is preferably just outside the opening from the paddle chamber to the mixing chamber for increased turbulence in the mixing chamber. A portion of the liquid flowing in the transfer pipe enters into the mixing chamber, mixes with the gas, and the mixture flows back into the transfer pipe.

### BACKGROUND

1. Technical Field

This disclosure generally relates to introducing a low density material into a higher density material, and more specifically relates to mixing of a low density material into a higher density material flowing in a transfer pipe using a mixer with at least one spinning paddle to create a highly turbulent mixing zone adjacent to the flow of the higher density material.

2. Background Art

There are many applications where it is desirable to mix a lower density material such as a gas into a higher density material such as a flow of a liquid. Some applications where it is desirable to mix a gas into a liquid include aerobic wastewater treatment systems, sewer lift stations, aerated lagoons, ozonation of water or other liquids, coal liquification, etc. These liquid flows may be pressurized or gravity flow. For example, in sewage treatment applications it is beneficial to dissolve oxygen and/or ozone gas into the liquid waste water to reduce bacteria that produces unwanted hydrogen sulfide gas. Similarly it is beneficial to introduce Carbon Dioxide into some liquids to reduce the PH of the liquid. Prior art devices and methods have been used with somewhat limited success to introduce and mix these gases into the liquid flow. For an example, see U.S. Pat. No. 7,553,447, incorporated herein by reference.

### BRIEF SUMMARY

The disclosure and claims herein are directed to a mixer that facilitates dissolving a lower density material into a higher density material using a rotating paddle to create a highly turbulent mixing zone in a mixing chamber adjacent to the flow of the higher density material. In an illustrated example, the mixer includes a motor that drives a mixing paddle to create a highly turbulent mixing of a liquid and a gas in the mixing chamber. The mixing paddle resides in a paddle chamber connected to the liquid transfer pipe by the mixing chamber. The mixing paddle is preferably just outside the opening from the paddle chamber to the mixing chamber for increased turbulence in the mixing chamber. A portion of the liquid flowing in the transfer pipe enters into the mixing chamber, mixes with the gas, and the mixture flows back into the transfer pipe.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 illustrates an example of the basic structure of a mixer as described and claimed herein;

FIG. 2 illustrates some possible positions for the mixing paddle as claimed herein;

FIG. 3 shows a cross-sectional end view of the sealed chamber taken along the lines 3-3 as shown in FIG. 1;

FIGS. 4a-d illustrate some examples of a mixing paddle;

FIGS. 5a-b illustrate another example of a mixing paddle;

FIGS. 6a-b illustrate another example of a mixing paddle; and

FIG. 6 is a method flow diagram for a mixer as claimed herein.

### DETAILED DESCRIPTION

Described herein is a mixer that facilitates dissolving a lower density material into a higher density material using a rotating paddle to create a highly turbulent mixing zone in a mixing chamber adjacent to the flow of the higher density material. In an illustrated example, the mixer includes a motor that drives a mixing paddle to create a highly turbulent mixing of a liquid, which is one example of a higher density material, with a gas, which is one example of a lower density material, in the mixing chamber. The mixing paddle resides in a paddle chamber which is a chamber connected to the liquid transfer pipe by the mixing chamber. The mixing paddle is preferably just outside the opening from the paddle chamber to the mixing chamber for increased turbulence in the mixing chamber. A portion of the liquid flowing in the transfer pipe enters into the mixing chamber, mixes with the gas, and the mixture flows back into the transfer pipe.

One of the problems with the prior art cited above was premature failure of the motor seals. In this prior design, particulates in the liquid flow could build up in the mixing chamber area and would settle directly on the motor seal resulting in premature failure of the seal. Another problem with the prior art design was inadequate mixing of the lower density material (gas) into the higher density material (liquid in the pressurized main). Rotating the paddle in the mixing chamber did not result in sufficient mixing of the materials. It was discovered that rotating the paddle outside the mixing chamber and just at the opening of the paddle chamber and the mixing chamber results in a much more turbulent mixing of the materials. Further, the perpendicular paddle chamber described herein reduces the amount of particulate matter buildup in the bottom of the chambers since the more turbulent flow moves most of the matter back into the transfer pipe. In addition, any heavy particulate matter that does accumulate in the mixer is at the bottom and not on the motor seal.

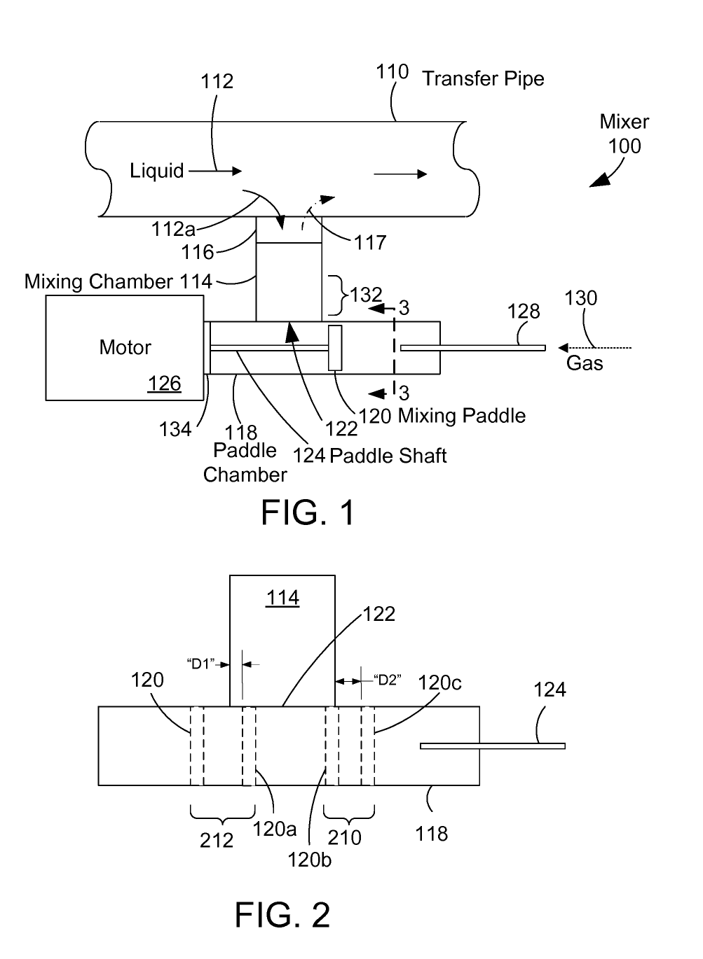

FIG. 1 illustrates an example of a basic structure for a mixer 100 as described and claimed herein. The mixer 100 is connected to a transfer pipe 110 that is used to transfer a higher density material. In this example, the higher density material is a liquid 112 such as waste water or sewage flowing under pressure in the transfer pipe 110. The mixing chamber 114 of the mixer 100 is preferably a pipe attached to the transfer pipe 110 by a valve 116. Attached to the mixing chamber 114 is a paddle chamber 118. The paddle chamber 118 is also preferably a cylindrical pipe with a circular shaped mixing paddle 120 as described further below. The mixing paddle 120 does not lie within or below the mixing chamber 114. The mixing paddle 120 is placed just inside the opening or just beyond an opening 122 between the paddle chamber 118 and the mixing chamber 114 as described further below. The mixing paddle 120 rotates on a paddle shaft 124 which provides a rotating axis for the mixing paddle. The paddle shaft 124 is preferably driven by a motor 126 outside the paddle chamber 118 through a sealed bearing 134. Preferably the paddle chamber 118 is perpendicular to the mixing chamber 114 with the rotating axis of the mixing paddle 120 parallel to the longitudinal axis of the paddle chamber 118 and perpendicular to the longitudinal axis of the mixing chamber 114. The paddle chamber 118 further includes an input tube 128 for introducing a lower density material such as a gas 130. The gas may be oxygen, ozone, nitrogen, carbon dioxide, chlorine, and hydrogen sulfide or other suitable gas. The lower density material could also be a liquid such as light or water soluble oils, solvents or other lower density liquids. Where the higher density liquid is heaver than water, then water could also be the lower density liquid. The relative density (greater density material/lower density material) is preferably greater than about 1.25.

Again referring to FIG. 1, the mixing chamber 114 and the paddle chamber 118 are preferably pressurizable chambers and have a pressure substantially equal to the pressure in the transfer pipe. The mixer described can be used at essentially any pressure depending on the application and the type of pipes and seals used. In most cases the pressure will range between atmospheric pressure (gravity flow) and a few hundred pounds per square inch. For example, in a forced sewer main, the pressure can be up to about 200 pounds per square inch (14.06 kg/m²). The materials used for the pipes of the mixer must be resistant to the liquids and gases used and will depend on the application. The mixer may be constructed of stainless steel to withstand the chemicals of the sewage and ozone gas that is injected into the paddle chamber as described below. Other common materials for the pipes include polyvinyl chloride (PVC), steel, etc. Similarly, the speed of the motor may vary depending on the application but will preferably be greater than about 500 revolutions per minute and most preferably about 1500 to 4000 revolutions per minute.

Again referring to FIG. 1, the operation of the mixer 100 will be further described. The mixer 100 facilitates dissolving a lower density material (a gas or liquid) into a higher density material (liquid) using a motor driven paddle that creates a highly turbulent mixing zone 132 in a lower portion of the mixing chamber 114. A portion 112a of the liquid 112 flowing in the transfer pipe 110 is allowed to enter into the mixing chamber 114. The flow can be introduced into the mixing chamber by opening the optional valve 116. The motor 126 drives the mixing paddle 120 in the paddle chamber to mix the gas is introduced at the input tube 128. The motor and mixing paddle are not used to pump the mixture. The mixing paddle 120 creates a turbulence of the liquid 112a and the gas 130 in the mixing zone 132 of the mixing chamber 114. Greater turbulence has been observed when the mixing paddle 120 partially overlapping or just outside the opening 122 from the paddle chamber 118 to the mixing chamber 114. The combination of the two materials results in a lower density for the mixture than the higher density material in the transfer pipe. Thus, as shown in this example, a portion 117 of the mixture of liquid and gas from the mixing chamber rises to mix with the liquid 112 in the transfer pipe 110 while a portion 112a of the liquid 112 enters the mixing chamber 114.

FIG. 2 illustrates possible positions for the mixing paddle as claimed herein. As mentioned above, greater turbulence has been observed when the mixing paddle 120 lies outside the opening 122 from the paddle chamber 118 to the mixing chamber 114. The preferred positions of the mixing paddle 120 are shown in FIG. 2. These positions include positions on the gas pipe side 210 or the motor side 212 of the mixing chamber. The mixing paddle is preferably positioned just inside the opening 120a, partially overlapping 120b the opening 122, and a short distance away 120c from the opening 122 as shown, or at some position between the examples shown in FIG. 2. The distance inside the opening 120a means the distance from the edge of the opening and the edge of the mixing paddle closest to the opening as shown by distance “D1” in FIG. 2. This distance is preferably less than about one fourth of the diameter of the mixing paddle 120. The distance away from the opening means the distance from the edge of the opening and the edge of the mixing paddle closest to the opening as shown by distance “D2” in FIG. 2. This distance is preferably less than the diameter of the mixing paddle 120 and most preferably about less than one half the diameter of the mixing paddle.

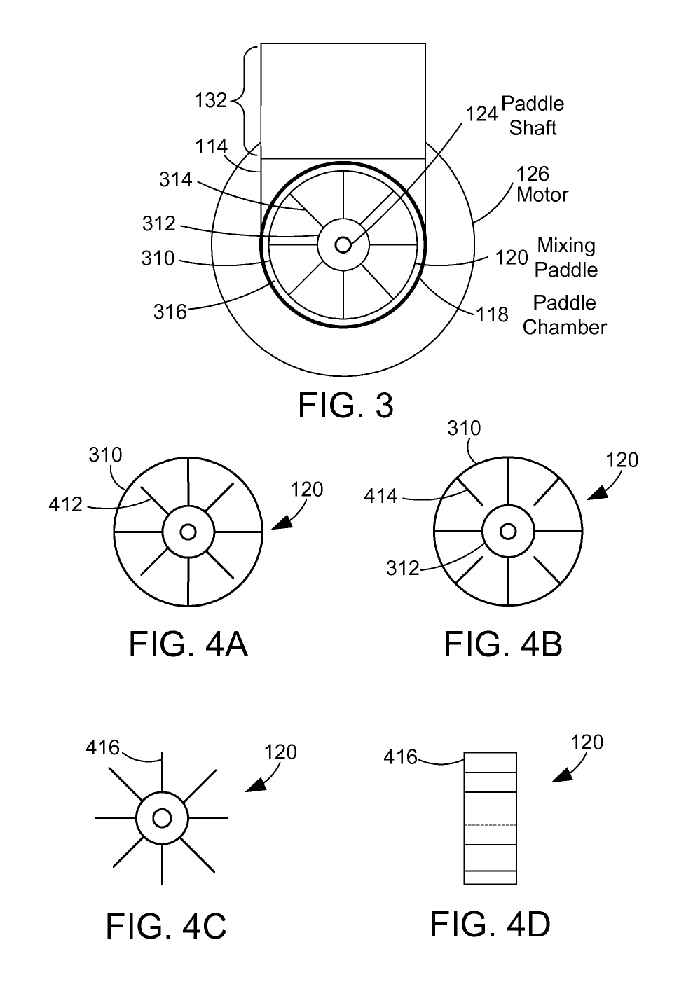

FIG. 3 shows a cross-sectional end view of the paddle chamber 118 taken along the lines 3-3 as shown in FIG. 1. The mixing chamber 114 with the mixing zone 132 is connected to the paddle chamber 118. The motor 126 is visible behind the paddle chamber 118. The mixing paddle 120 rotates inside the paddle chamber 118 on the paddle shaft 124. In this example, the mixing paddle 120 has an outer ring 310 connected to an inner ring 312 by eight vanes 314. Other variations of the mixing paddle are described below with reference to FIGS. 4-6. The mixing paddle 120 is preferably about the same diameter as the paddle chamber 118. FIG. 3 further illustrates a small clearance 316 between the mixing paddle 120 and the paddle chamber 118. This clearance is preferably no larger than necessary to prevent interference between the rotating mixing paddle 120 and the paddle chamber 118. Mixing paddles substantially smaller than the paddle chamber could also be used, but smaller mixing paddles will require significantly greater speeds to get the same turbulent mixing in the mixing zone 132. A mixing paddle could range from about 30 to 99% of the diameter of the paddle chamber. A preferred mixing paddle is about 80 to 99% and most preferably about 95-99% of the paddle chamber diameter while ensuring the needed clearance. In this example, the motor 126 rotates an approximately 3.9 inch (9.9 cm) mixing paddle at about 1750 revolutions per minute (RPM) with a clearance of about 0.10 inch (0.25 cm) where the pipe of the paddle chamber has an inner diameter of 4 inches (10.2 cm). Similarly a paddle of about 1.9 inches (4.83) could be used with a pipe having a 2 inch (5.08 cm) inside diameter.

FIGS. 4a-c illustrate some examples of mixing paddles 120 that can be used with the mixer 100 described above. FIG. 4a illustrates a mixing paddle 120 where some of the vanes 412 do not extend to the outer ring 310. FIG. 4b illustrates a mixing paddle 120 where some of the vanes 414 do not extend all the way to the inner ring 312 from the outer ring 310. FIG. 4c illustrates a mixing paddle 120 where there is no outer ring connecting the vanes 416. This mixing paddle is similar to a propeller but does not require the vanes to be shaped to push the liquid and gas mixture. The vanes 416 are preferably substantially flat with their longitudinal axis perpendicular to the motor shaft but may be shaped like a common propeller. The mixing paddle may be constructed of a suitable material depending on the characteristics of the materials being mixed.

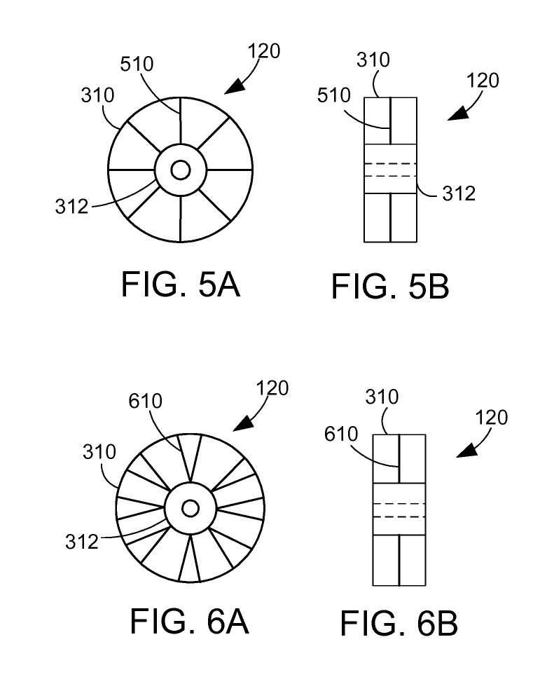

FIGS. 5a-b illustrate another example of a mixing paddle 120 that can be used with the mixer 100 described above. FIG. 4a illustrates a mixing paddle 120 where the vanes 510 are cylindrical shaped or a wire extending from the hub 312 to the outer ring 310. FIG. 5b illustrates a side view of the mixing paddle 120 shown in FIG. 5a.

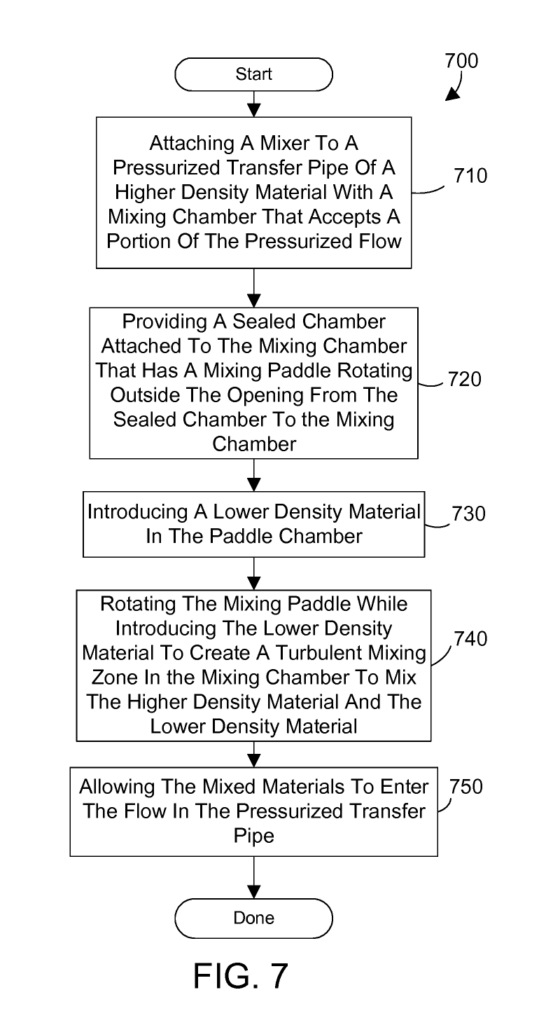

FIGS. 6a-b illustrate another example of a mixing paddle 120 that can be used with the mixer 100 described above. FIG. 6a illustrates a mixing paddle 120 where the vanes 610 are triangular shaped extending from the hub 312 to the outer ring 310. FIG. 6b illustrates a side view of the mixing paddle 120 shown in FIG. 6a.

FIG. 6 shows a method 600 for mixing a lower density material such as a gas with a higher density material such as a liquid as disclosed and claimed herein. First, attach a mixer to a transfer pipe of a higher density material with a mixing chamber that accepts a portion of the flow of higher density material (step 610). Then provide a paddle chamber attached to the mixing chamber that has a mixing paddle rotating outside the opening from the sealed chamber to the mixing chamber (step 620). Introduce a lower density material into the sealed chamber (step 630). Then rotate the mixing paddle while introducing the lower density material to create a turbulent mixing zone in the mixing chamber to mix the higher density material and the lower density material (step 640). Then allow the mixed higher and lower density materials to enter the flow in the transfer pipe. The method is then done.

While specific materials are discussed herein by way of example, one skilled in the art will recognize that different materials could be used for different applications. For example, if the liquid or gas presents a caustic environment, various materials that resist such a caustic environment could be used, including plastic and composite materials. The disclosure and claims herein expressly extend to any suitable material, whether currently known or developed in the future. Further, the liquid that is processed in the mixer may be any suitable liquid, and preferably includes clean water, sewage water, pond water, and lake water. While the examples described above refer to oxygen as the gas, other gases could also be used. Other preferred gases include ozone, nitrogen, carbon dioxide, and chlorine. Other low density materials could be used such as a lower density liquid than the liquid flowing in the transfer pipe. The disclosure and claims here expressly extend to these gases and other suitable low density materials.

As described herein, a mixer that facilitates dissolving a lower density material into a higher density material using a using spinning paddle to create a highly turbulent mixing zone in a mixing chamber adjacent to the flow of the higher density material. A portion of the liquid flowing in the transfer pipe enters into the mixing chamber, mixes with the gas, and the mixture flows back into the transfer pipe. The mixing paddle preferably lies outside the opening from the paddle chamber to the mixing chamber for increased turbulence in the mixing chamber.

One skilled in the art will appreciate that many variations are possible within the scope of the claims. While the examples herein are described in terms of time, these other types of thresholds are expressly intended to be included within the scope of the claims. Thus, while the disclosure is particularly shown and described above, it will be understood by those skilled in the art that these and other changes in form and details may be made therein without departing from the spirit and scope of the claims.

1) An apparatus comprising:
a mixing chamber connected to a transfer pipe for transferring a material with a first density;
a paddle chamber with an opening connecting the paddle chamber to the mixing chamber;
an input pipe that introduces a second density material into the paddle chamber, wherein the second density material is lower density than the first density material;
a mixing paddle that rotates in the paddle chamber on an axis, wherein the paddle chamber is perpendicular to the mixing chamber with the rotating axis of the mixing paddle parallel to a longitudinal axis of the paddle chamber and perpendicular to a longitudinal axis of the mixing chamber;
wherein the mixing paddle rotates in the paddle chamber to create a turbulent mixing zone in the mixing chamber that provides a mixture of the second density material and the first density material and a portion of the mixture flows into the transfer pipe from the mixing chamber, and
wherein the mixing paddle is located from inside the opening of the paddle chamber about 25 percent of the diameter of the mixing paddle to outside the opening of the paddle chamber a distance about the diameter of the mixing paddle.

2) The apparatus of claim 1 wherein the first density material is a liquid and the second, lower density material is a gas.

3) The apparatus of claim 1 wherein the first density material is a first liquid and the second density material is a second liquid of lower density than the first liquid.

4) The apparatus of claim 3 wherein the mixing paddle is partially overlapping the opening in the paddle chamber.

5) The apparatus of claim 1 wherein the mixing paddle is outside the opening in the paddle chamber but within a distance of less than about one half of a diameter of the mixing paddle.

6) The apparatus of claim 1 wherein the mixing paddle has a plurality of vanes connected between an inner ring and an outer ring.

7) The apparatus of claim 2 wherein the liquid is chosen from the following:
clean water, sewage water, pond water, and lake water.

8) The apparatus of claim 2 wherein the gas is chosen from the following:
oxygen, ozone, nitrogen, carbon dioxide, and chlorine.

9) An apparatus comprising:
a mixing chamber connected to a transfer pipe for transferring a liquid;
a paddle chamber connected to the mixing chamber with an input pipe that introduces a gas into the paddle chamber, wherein the paddle chamber is perpendicular to the mixing chamber with the rotating axis of the mixing paddle parallel to a longitudinal axis of the paddle chamber and perpendicular to a longitudinal axis of the mixing chamber;
a mixing paddle that rotates in the paddle chamber on an axis;
wherein the mixing paddle rotates in the paddle chamber to the mixing chamber to create a turbulent mixing zone in the mixing chamber that provides a mixture of the gas and the liquid, and a portion of the mixture flows into the transfer pipe from the mixing chamber, and
wherein the mixing paddle is located from inside the opening of the paddle chamber about 25 percent of the diameter of the mixing paddle to outside the opening of the paddle chamber a distance about the diameter of the mixing paddle.

10) The apparatus of claim 9 wherein the mixing paddle is outside the opening in the paddle chamber but within a distance of less than about one half of a diameter of the mixing paddle.

11) The apparatus of claim 9 wherein the mixing paddle has a plurality of vanes connected between an inner ring and an outer ring.

12) The apparatus of claim 9 wherein the liquid is chosen from the following:
clean water, sewage water, pond water, and lake water.

13) The apparatus of claim 9 the gas is chosen from the following:
oxygen, ozone, nitrogen, carbon dioxide, and chlorine.

14) A method for mixing a lower density material with a higher density material, the method comprising the steps of:
(A) attaching a mixer to a transfer pipe of a higher density material with a mixing chamber that accepts a portion of the flow of higher density material;
(B) providing a paddle chamber with an opening to the mixing chamber that has a mixing paddle;
(C) introducing a lower density material into the sealed chamber; and
(D) rotating the mixing paddle while introducing the lower density material to create a turbulent mixing zone in the mixing chamber to mix the higher density material and the lower density material, wherein the mixing paddle is located from inside an opening of the paddle chamber about 25 percent of the diameter of the mixing paddle to outside the opening of the paddle chamber a distance about the diameter of the mixing paddle.

15) The method of claim 14 further comprising the steps of:
(E) Then allow the mixed higher and lower density materials to enter the flow in the transfer pipe.

16) The method of claim 14 wherein the higher density material is a liquid and the lower density material is a gas.

17) The method of claim 14 wherein the paddle chamber is perpendicular to the mixing chamber with the rotating axis of the mixing paddle parallel to the paddle chamber and perpendicular to the mixing chamber.

18) The method of claim 14 wherein the mixing paddle is outside but partially overlapping the opening in the paddle chamber.

19) The method of claim 14 wherein the mixing paddle is outside the opening in the paddle chamber but within a distance of less than about ½ of a diameter of the mixing paddle.

20) The method of claim 16 wherein the gas is chosen from the following:
oxygen, ozone, nitrogen, carbon dioxide, and chlorine.
